(19) United States
(12) Patent Application Publication
(10) Pub. No.: US 2026/0309346 A1
(43) Pub. Date: Oct. 8, 2026

(54) Air Filter

(71) Applicant: Zhongshan Scott Clean&Purification Co., Ltd., Guangdong (CN)

(72) Inventor: Junjiao HU, Guangdong (CN)

(73) Assignee: Zhongshan Scott Clean&Purification Co., Ltd., Guangdong (CN)

(21) Appl. No.: 19/098,163

(22) Filed: Apr. 2, 2025

(51) Int. Cl. F24F 8/108; B01D 46/00; B01D 46/10; B01D 46/52; F24F 8/175

(52) U.S. Cl. CPC F24F 8/108; B01D 46/0001; B01D 46/10; B01D 46/523; F24F 8/175

(57) ABSTRACT

The present disclosure provides an air filter, which comprise a frame and air filter media disposed in the frame, the frame surrounding the air filter media in an airtight joint manner, and the air filter media being folded in a pleated manner to form a plurality of continuous and adjacent pleated sections; and a join line group, which comprises a plurality of fine join lines, each fine join line connecting at least two pleated sections and being used to limit the unfolding distance between the pleated sections; wherein, at least some of the fine join lines are disposed between two adjacent pleated sections.

### TECHNICAL FIELD

The present disclosure relates to the field of air purification, and particularly to a foldable air filter with adjustable width.

### BACKGROUND

In existing air purification and ventilation equipment, the air filter is usually fixedly connected to the frame by hot-melting. Most fresh air filters are discarded as a whole after the filter media material expires, or the old filter media material is replaced with the help of tools.

An existing US patent application with a publication number of 20230311045A1 discloses a filter element media component, including two frames, wherein the two frames are oppositely arranged and are not connected. The filter element media is unfolded by first pulling the separation strips to detach them from the two frames, and then separately pulling the two frames located at both ends of the filter element media.

However, this fixed connection method makes the width of the air filter unadjustable. Although the width of the foldable air filter can be controlled by incomplete unfolding, the pleated structure therein often unfolds unevenly, which affects the use effect.

### SUMMARY

The present disclosure provides an air filter, which includes a frame having a top frame and a bottom frame arranged oppositely; and air filter media disposed between the top frame and the bottom frame, folded in a pleated manner to form a plurality of continuous and adjacent pleated sections; and a join line group comprising a plurality of fine join lines, each fine join line connecting at least two pleated sections and being configured to limit an unfolding distance between the pleated sections; wherein, at least some of the fine join lines are disposed between two adjacent pleated sections.

### BRIEF DESCRIPTION OF DRAWINGS

The drawings, which form a part of this application, are used to provide a further understanding of the present disclosure. The schematic embodiments of the present disclosure and the descriptions thereof are used to explain the present disclosure and do not constitute an improper limitation of the present disclosure. In the drawings:

FIG. 1 shows a schematic structural diagram of an embodiment of the air filter according to the present disclosure;

FIG. 2 shows a schematic cross-sectional structure diagram of the air filter media in FIG. 1;

FIG. 3 shows another schematic cross-sectional structure diagram of the air filter media in FIG. 2;

FIG. 4 shows a schematic structural diagram of the fine join lines of the air filter media in FIG. 1;

FIG. 5 shows a schematic diagram of the frame structure of the air filter media in FIG. 1;

FIG. 6 shows a schematic diagram of the exploded frame structure of the air filter media in FIG. 5;

FIG. 7 shows a schematic diagram of the left and right frames of the air filter media in FIG. 5;

FIG. 8 shows a schematic diagram of the left or right frame of the air filter media in FIG. 5;

The above drawings include the following reference signs:

Air filter media (1); Frame (2); join line group (3); Pleated section (11); Pleat tip (12); Left panel (14); Right panel (15); Top frame (21); Bottom frame (22); Left frame (23); Right frame (24); First connecting hole (25); Second connecting hole (26); Lateral plate (27); Aperture (28); Scale (29); Fine join line (31); Stop end (32); Left join line group (A); Central join line group (B); Right join line group (C); Connecting block (41); Metal mesh layer (51).

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

The width of the existing air filter cannot be well adjusted and cannot adapt to different usage scenarios. When unfolded, the pleated structure of the air filter unfolds unevenly, which affects the usage effect.

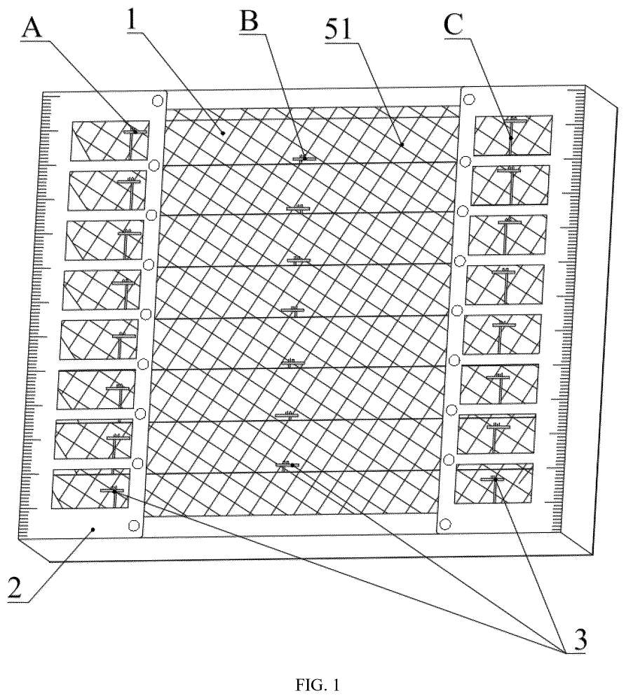

The air filters proposed in this invention are mainly used in air conditioning system, HAVC, furnace and air purifier etc., As shown in FIG. 1, the present disclosure provides a high-efficiency air filter device, which includes a frame 2 and air filter media 1 disposed in the frame 2. The frame 2 surrounds the air filter media 1 in an air-tight joint manner to ensure that air can only pass through the air filter media and cannot leak from the edge of the frame 2. The air filter media 1 is folded in a pleated manner to form a plurality of continuous and adjacent pleated sections 11, thereby increasing the filtration area and improving the filtration efficiency.

In addition, the present disclosure also includes a join line group 3, and the join line group 3 includes a plurality of fine join lines 31. Each fine join line 31 connects at least two different pleated sections 11 and is used to limit the unfolding distance between the pleated sections 11 to ensure that the air filter media maintains a stable structure during use. At least part of the plurality of fine join lines 31 is disposed between two adjacent pleated sections 11. Each pleated section 11 includes a folding line defining a pleat tip 12 and a pair of adjacent panels, and the fine join lines 31 extend through the panels.

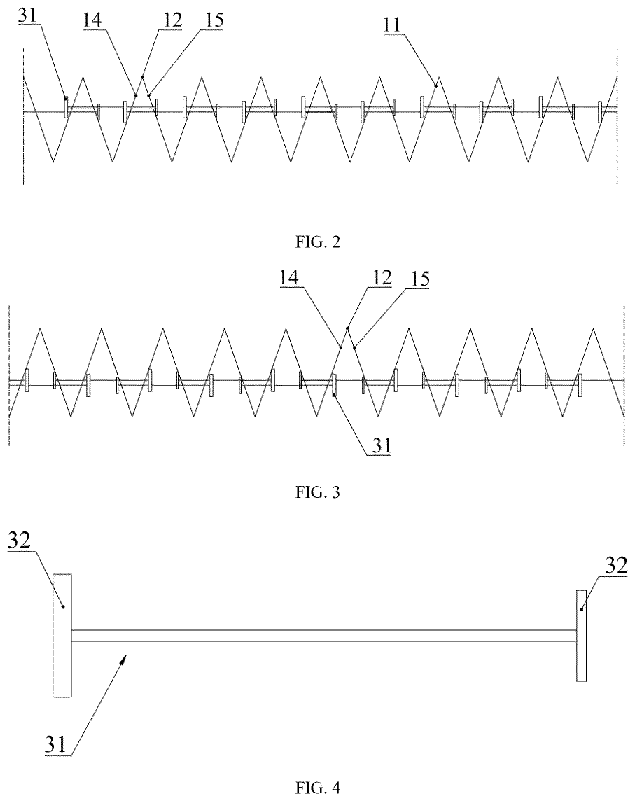

As shown in FIG. 2, in this embodiment, the fine join lines 31 are arranged between two adjacent pleated sections 11 and penetrate the panels of each pleated section 11. Each pleated section 11 includes a folding line defining the pleat tip 12, as well as a left panel 14 and a right panel 15 adjacent to the folding line. Two adjacent pleated sections 11 are arranged at left and right (here, left and right are determined by the cross-sectional view of the air filter media). At least one end of some of the fine join lines 31 among the plurality of fine join lines 31 penetrates through the left panel 14 of the left pleated section 11, and the other end penetrates through the right panel 15 of the right pleated section 11.

In this embodiment, the air filter media 1 is provided with three join line groups 3, namely a left join line group A, a central join line group B, and a right join line group C. The central join line group B is arranged in the middle of the air filter media 1, and the left join line group A and the right join line group C are respectively arranged on the left and right outer sides of the central join line group B. A plurality of fine join lines 31 in the same group are continuously arranged and linearly arranged. Each two groups of the three join line groups 3 extend parallel to each other, and the three join line groups 3 are not on the same plane. Specifically, the left join line group A and the right join line group C are located on the first plane, the central join line group B is located on the second plane, and the second plane is parallel to the first plane. In some embodiments, by arranging three join line groups 3 at the upper, middle, and lower parts of the air filter media 1, the unfolding distances between the pleated sections 11 at different positions can be respectively limited, so that the unfolding of the entire air filter media 1 is more uniform. However, in this embodiment, the upper, middle, and lower parts of the air filter media 1 are mainly unfolded evenly at equal distances.

The fine join lines 31 of the left join line group A and the right join line group C are arranged at positions close to the pleat tip 12, with one end penetrating the left panel 14 of the left pleated section 11 and the other end penetrating the right panel 15 of the right pleated section 11. The fine join lines 31 of the central join line group B are arranged at positions farther from the pleat tip 12 than the fine join lines 31 of the left join line group A and the right join line group C. Alternatively, the fine join lines 31 of the central join line group B are arranged at positions close to the pleat tip 12, with one end penetrating the left panel 14 of the left pleated section 11 and the other end penetrating the right panel 15 of the right pleated section 11. The fine join lines 31 of the left join line group A and the right join line group C are arranged at positions farther from the pleat tip 12 than the fine join lines 31 of the central join line group B.

As shown in FIG. 3, in this embodiment, three consecutive pleated sections 11 are arranged in a left, middle, and right configuration. At least part of the fine join lines 31 among the plurality of fine join lines 31 have one end passing through the right panel 15 of the left pleated section 11, the other end passing through the left panel 14 of the right pleated section 11, and the middle part passing through the left panel 14 and the right panel 15 of the middle pleated section 11. In this embodiment, it mainly refers to the join line group 3 that is relatively farther from the pleat tip 12. In practical applications, the connection design between the fine join lines 31 and the air filter media 1 can also be diverse. In addition to the above method, the fine join lines 31 can also be connected to the left panel 14 of one pleated section 11 and the left panel 14 of another adjacent pleated section 11, or the fine join lines 31 can be connected to the left panel 14 of one pleated section 11 and the right panel 15 of another pleated section 11 adjacent to this left panel 14.

Actually, when the air filter media 1 is folded in a pleated manner, it has two opposite sides. The above-mentioned pleat tip 12 is defined as the top of the pleat on one side of the air filter media 1 when this side faces upward. Therefore, when the air filter media 1 is turned over and the other side faces upward, it can also be considered to have a pleat tip 12.

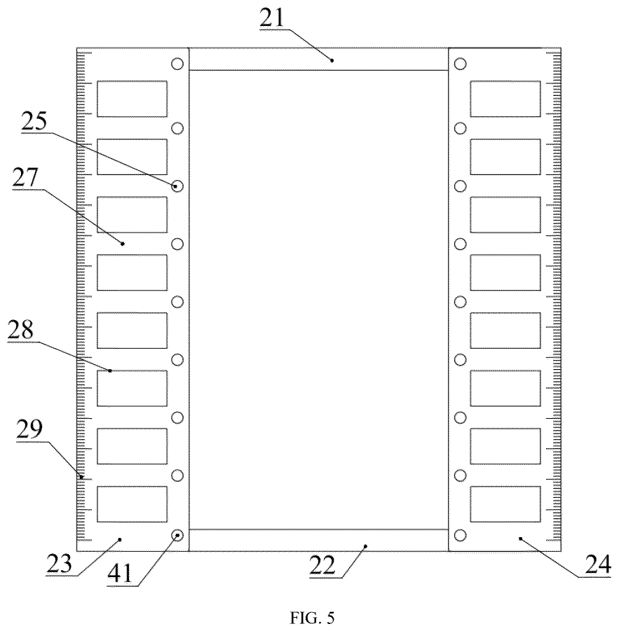

As shown in FIG. 4, both ends of the fine join line 31 are respectively provided with a stop end 32. The stop end 32 is used to prevent the panel from passing through, thereby restricting the relative unfolding of the two panels. Both ends of the fine join line 31 can be directly connected and fixed to the panel, or can be connected to the panel through the stop end 32, or may not be directly connected to the panel. When the fine join line 31 is directly connected to the panel, the fine join line 31 can be designed to have good flexibility. It is in a relaxed state when not under force and in a tensioned state when under force to limit the expansion distance between the pleated sections 11. In this embodiment, the stop end 32 of the fine join line 31 is configured as a “T” shape, and the two sides of the “T” shape of the stop end 32 are used to prevent the panel from passing through. In some embodiments, an adjustable “T”-shaped stop end 32 can be designed, allowing users to adjust the position of the stop end 32 according to actual needs, thereby flexibly controlling the expansion distance of the panel.

By threading fine join lines 31 between the pleated sections 11, the folded filter media can be evenly unfolded. Here, “threading” means that the fine join lines 31 are directly set to penetrate through each pleated section 11 without relying on adhesives or other methods. This also makes the fine join lines 31 less likely to fall off under stress. Further, even when the air filter media 1 is unfolded in an arc shape, it still has a certain stability, reducing the situation where a certain section of the air filter media 1 is blown out after being stressed, and avoiding the problem of uneven unfolding of the pleated structure, thereby improving the air filtration effect. The fine join lines 31 have a simple structure and low cost, which is beneficial to reducing manufacturing costs and resource consumption.

As shown in FIG. 5, the air filter media 1 is folded in an accordion manner, with zigzag edges on the left and right sides and flat panels on the upper and lower sides. The frame 2 is composed of a top frame 21, a bottom frame 22, a left frame 23, and a right frame 24. The top frame 21 and the bottom frame 22 are connected to the upper and lower flat panels of the air filter media 1. The left frame 23 is connected to the upper ends of the top frame 21 and the bottom frame 22, and the right frame 24 is connected to the lower ends of the top frame 21 and the bottom frame 22. The left and right edges of the air filter media 1 are compressed by the left frame 23 and the right frame 24 to achieve an airtight combination, providing excellent airtightness. In addition, the left and right edges of the air filter media 1 can be designed to have a longer margin so that they can be compressed by the left frame 23 and the right frame 24 after being bent, thereby further enhancing the airtight combination effect; or further, a special sealant or adhesive can be used to bond the two surfaces together to form an air seal; or a gasket or sealing ring made of rubber or other elastic materials can be placed between the joint surfaces to achieve an air seal by compressing the joint surfaces.

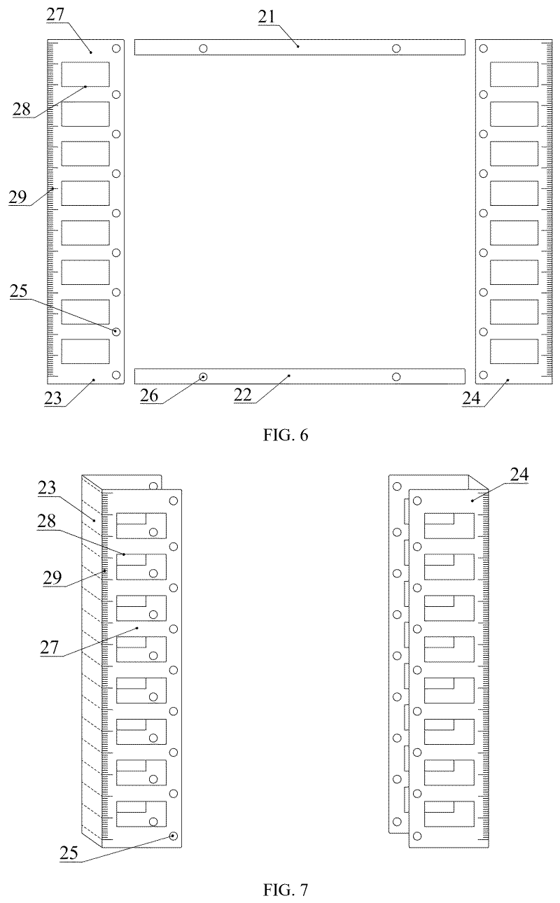

As shown in FIG. 6, a plurality of first connecting holes 25 are provided on both the left frame 23 and the right frame 24. Second connecting holes 26 for connecting with the first connecting holes 25 are also provided on both the top frame 21 and the bottom frame 22. Lateral plates 27 are formed by extending on both the front and back sides of the left frame 23 and the right frame 24. The first connecting holes 25 are provided on the lateral plates 27. Scale lines are also provided on the front and back sides of the left frame 23 and the right frame 24. The scale 29 is set along the length of the left frame 23 or the right frame 24, realizing the adjustable design of the frame 2. The top frame 21 and the bottom frame 22 are relatively expanded according to the required width of the air filter media 1. The left frame 23 or the right frame 24 has scales 29 printed on both sides according to the width between the top frame 21 and the bottom frame 22. With the assistance of the scale 29, it can be DIY cut to a suitable length, so that customers can intuitively cut according to their needs. Then, through the cooperation of the first connecting holes 25 and the second connecting holes 26, the left frame 23 and the right frame 24 are connected to the top frame 21 and the bottom frame 22 to keep the frame relatively stable, providing a larger adjustment range. The connection between the first connecting holes 25 and the second connecting holes 26 is completed by inserting the connecting block 41, realizing that the frame 2 can be adjusted in width to adapt to the air filter media 1 expanded to different widths, so as to adapt to different usage scenarios and improve the versatility and application range of the air filter. At the same time, the frame 2 has a compact structure and a small volume, which is convenient for transportation and storage and reduces the cost. The frame 2 adopts a detachable connection structure, which is convenient for the installation and replacement of the folded filter media and is easy to operate. In addition to the connecting block 41, the connection methods between the left-side frame 23 and both the top frame 21 and bottom frame 22, as well as between the right-side frame 24 and both the top frame 21 and bottom frame 22, may alternatively employ fastening techniques such as nailing, adhesive bonding, or fixation using plastic components.

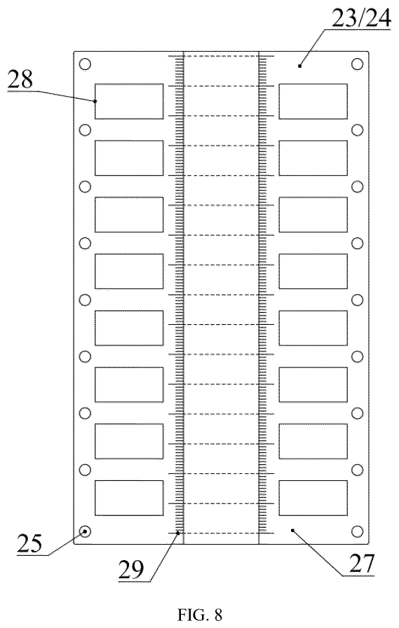

As shown in FIGS. 5-8, the air filter frame 2 adopts a modular adjustable design. Lateral plates 27 are provided on both the front and back sides of the left frame 23 and the right frame 24. A plurality of groups of first connecting holes 25 and the matching second connecting holes 26 are distributed on the lateral plates 27, and a scale 29 is marked along the length direction, which is convenient for users to accurately adjust. When in use, first the unfolding sizes of the top frame 21 and the bottom frame 22 are adjusted according to the actual width of the air filter media 1, then the left frame 23 and the right frame 24 are quickly cut to the required length according to the scale 29, and finally the assembly is completed by inserting the connecting block 41 into the corresponding holes. This design not only enables the frame 2 to flexibly adapt to air filter media 1 of different specifications, improving the versatility, but also maintains the compactness of the overall structure, facilitating transportation and storage. At the same time, it simplifies the installation process and improves the convenience of use.

As shown in FIG. 5-8, both the front and rear sides of the lateral plate 27 are provided with arrayed apertures 28. This design has a plurality of optimization effects: first, by increasing the effective ventilation area, the airflow passage is significantly improved; second, on the premise of ensuring the strength of the frame 2, the scientifically arranged structure of the apertures 28 reduces the weight and effectively lowers the system air resistance; meanwhile, the precisely calculated size of the apertures 28 can not only ensure the air circulation efficiency but also prevent the accidental detachment of the air filter media 1. This innovative ventilation structure design enables the entire filtration system to achieve collaborative optimization in terms of air permeability, lightweight, and safety, providing a reliable guarantee for efficient air filtration.

With the symmetrically arranged expandable structures with scale lines on the left and right frames, the first connecting holes and the corresponding second connecting holes are distributed on the lateral plates extending from the front and back sides. The width of the frame can be adjusted by the cooperation of the connecting block. Combined with the scale set along the frame, the air filter media of different specifications can be intuitively cut to fit, thereby forming a compact frame system with detachable and easily adjustable features is formed. While ensuring the structural stability, it also has the advantages of convenient transportation, flexible installation, and strong adaptability to different scenarios, significantly improving the universality and economy of the air filter.

The air filter media 1 includes a first layer and a second layer that are attached to each other. The first layer is an adsorption layer with electrostatic adsorption function, and the second layer is a non-woven fabric containing micro-encapsulated probiotics and extracts of Murraya exotica L. The first layer adsorbs allergens such as dust in the air through static electricity, and the probiotics and extracts of Murraya exotica L. on the second layer devour the allergens on the first layer.

The electrostatic fibers or electrostatic filter media is cut into the required size and shape to prepare the first layer. It is ensured that static electricity is evenly distributed on the material surface to improve the adsorption effect. The non-woven fabric is cut into the same size and shape as the first layer. The probiotics are embedded into the non-woven fabric through micro-encapsulation technology to prepare the second layer. The micro-encapsulation technology can protect the activity of the probiotics and release them when needed.

The first-layer and second-layer materials are stacked together to ensure that the two layers are closely attached. Appropriate adhesives or hot-pressing technology are used to bond the two layers together to form an integral air filter media.

Micro-encapsulated probiotics are formed by encapsulating probiotics in tiny capsules through micro-encapsulation technology to protect the probiotics from the external environment, thereby improving their survival rate and stability. This technology can effectively isolate the probiotics from unfavorable factors such as light, oxygen, and temperature, enabling them to remain active during processing, storage, and use. Among them, the probiotic components include beneficial intestinal flora such as Lactobacillus, yeast, and Bifidobacterium.

Among them, Murraya exotica L. is an evergreen shrub or small tree of the genus Murraya in the Rutaceae family. The extract of the Murraya exotica L. is mixed with an adhesive and added to non-woven fabrics. The Murraya exotica L. has various medicinal values and effects:

1. Anti-inflammatory effect: The Murraya exotica L. contains some compounds that can inhibit the growth of bacteria and fungi and help reduce the inflammatory response. Studies have shown that its extract has a significant inhibitory effect on certain pathogenic microorganisms.

2. Analgesic effect: The leaves and roots of the Murraya exotica L. are often used to relieve pain, such as headaches and joint pains. This may be related to the volatile oil components it contains, which can exert analgesic effects through external application or internal administration.

3. Spleen and stomach strengthening function: The Murraya exotica L. can be used to improve symptoms such as indigestion and loss of appetite and has the function of strengthening the spleen and stomach. It is often used in traditional medicine to regulate gastrointestinal discomfort.
4. Promoting qi circulation and activating blood circulation: The Murraya exotica L. is considered to be able to promote blood circulation and relieve various discomforts caused by qi stagnation and blood stasis, and it is often used to treat diseases such as dysmenorrhea and amenorrhea.

Flavonoid components such as Rutin and Quercetin have been isolated from the Murraya exotica L. Studies have confirmed that they reduce the release of inflammatory factors by inhibiting the NF-κB pathway (Pharmaceutical Biology, 2016); Scopoletin has anti-inflammatory and antibacterial activities (Journal of Natural Products, 2012).

The main components of the volatile oil of the Murraya exotica L. include Limonene, β-Caryophyllene, and Linalool. Experiments have shown that it can inhibit pain through the TRP channel (Evidence-Based Complementary and Alternative Medicine, 2020); Murrayanine is its characteristic alkaloid and has a local analgesic effect. In the literature, “Murrayanine” is often referred to as Murrayacine or Murrayanine (Phytochemistry, 2005).

Alkaloid: N-methylflindersine is the main alkaloid in the roots of the Murraya exotica L. and can promote gastrointestinal peristalsis (Fitoterapia, 2018).

The Murraya exotica L. contains compounds such as flavonoids (Rutin, Quercetin), coumarins (Scopoletin), volatile oils (Limonene, β-Caryophyllene), alkaloids (Murrayanine), and terpenoids (triterpenoid saponins). The presence of relevant compounds in the Murraya exotica L. has been verified by analytical techniques such as HPLC and GC-MS (refer to Phytochemical Analysis, 2021).

The flowers, leaves, and fruits of Murraya exotica L. all contain essential oils, with an oil yield of 0.25%. The leaves and flowers contain 1.4%-1.6% essential oils, and the main components are isolongifolene, germacrene-β, and citral. The leaves of Murraya exotica L. contain various coumarin compounds, such as Isomexoticin, Murpanidin, Murpanicin, and Murrangatin which can be used in cosmetic and food flavors. The wood of Murraya exotica L. is hard and dense and can be used to make delicate handicrafts.

The first layer electrostatically adsorbs allergens such as dust in the passing air. The probiotics on the second layer and the non-woven fabric of Murraya exotica L. extract devour the allergens on the first layer, enabling the air filter element to process the allergens in it. The air filter element has a certain self-cleaning ability and can still maintain a certain filtering ability after long-term use or storage.

The air filter media 1 is provided with a support layer for supporting the shaping of the air filter media 1. The support layer includes a metal mesh layer 51 that can be deformed and folded in a pleated manner with the air filter media 1. The metal mesh layer 51 is specifically a front-placed aluminum alloy planar mesh layer, and the thickness of the metal mesh layer 51 is from 2 mm to 1 mm. The metal mesh layer 51 can be plastically deformed and provides a certain support performance.

From the above description, it can be seen that the above-mentioned embodiments of the present disclosure achieve the following technical effects: by limiting the unfolding distance between the pleated sections through the join line group, the width of the air filter can be adjusted according to actual needs, improving the flexibility of use; the join line group makes the unfolding of the pleated sections more uniform, avoiding the problem of uneven unfolding of the pleated structure in the existing folded air filter, and improving the filtering effect; the design of the stop end of the fine join line can effectively limit the relative unfolding distance of adjacent panels, further ensuring the uniformity of the unfolding of the pleated sections; by setting three join line groups on the upper, middle, and lower parts of the air filter media, the unfolding distances between the pleated sections at different positions can be respectively limited, making the unfolding of the entire air filter media more uniform; the setting of the join line group avoids fixed connection methods such as hot-melting, enabling the air filter media to be easily disassembled and replaced, prolonging the service life and reducing the maintenance cost.

In the description of the present disclosure, it should be appreciated that directional terms such as “front, rear, up, down, left, right”, “horizontal, vertical, perpendicular, horizontal” and “top, bottom” etc. indicate the orientation or positional relationship based on the orientation or positional relationship shown in the drawings, and are only for the convenience of describing the present disclosure and simplifying the description. In the absence of a contrary explanation, these directional terms do not indicate or imply that the device or element referred to must have a specific orientation or be constructed and operated in a specific orientation, and therefore should not be understood as limiting the scope of protection of the present disclosure; the directional terms “inside, outside” refer to the inside and outside relative to the contour of each component itself.

For the convenience of description, spatial relative terms such as “on . . . ” , “above . . . ”, “on the upper surface of . . . ”, “upper” etc. may be used here to describe the spatial positional relationship of a device or feature with other devices or features as shown in the drawings. It should be appreciated that spatial relative terms are intended to encompass different orientations of the device in use or operation other than the orientation described in the drawings. For example, if the device in the drawing is inverted, the device described as “above other devices or structures” or “on other devices or structures” will subsequently be positioned as “below other devices or structures” or “under other devices or structures”. Thus, the exemplary term “above” can include both “above” and “below” orientations. The device can also be positioned in other different ways (rotated 90 degrees or in other orientations), and the spatial relative descriptions used here should be interpreted accordingly.

In addition, it should be noted that the use of terms such as “first”, “second” etc. to define components is for the convenience of distinguishing the corresponding components. Unless otherwise stated, the above terms have no special meaning, and therefore should not be understood as limiting the scope of protection of the present disclosure.

The above description is only a preferred embodiment of the present disclosure and is not intended to limit the present disclosure. For those skilled in the art, the present disclosure can have various modifications and changes. Any modifications, equivalent replacements, improvements etc. made within the spirit and principles of the present disclosure should be included within the scope of protection of the present disclosure.

What is claimed is:

1. An air filter, comprising:
a frame having a top frame and a bottom frame arranged oppositely; and
air filter media disposed between the top frame and the bottom frame, folded in a pleated manner to form a plurality of continuous and adjacent pleated sections; and
a join line group comprising a plurality of fine join lines, each fine join line connecting at least two pleated sections and being configured to limit an unfolding distance between the pleated sections;
wherein, at least some of the fine join lines are disposed between two adjacent pleated sections.

2. The air filter according to claim 1, wherein each pleated section comprises a folding line defining a pleat tip and a pair of adjacent panels, and the fine join line extends through the panels.

3. The air filter according to claim 2, wherein the fine join lines are disposed between two adjacent pleated sections and penetrate through the panels, and each pleated section comprises a folding line defining a pleat tip and a left panel and a right panel adjacent to the folding line, wherein two adjacent pleated sections are respectively arranged at left and right, one end of at least some of the fine join lines passes through the left panel of a left pleated section, and the other end passes through the right panel of a right pleated section.

4. The air filter according to claim 3, wherein both ends of the fine join line are respectively provided with stop ends, and the stop ends are configured to prevent the panels from passing through, thereby limiting a relative unfolding of the two panels.

5. The air filter according to claim 4, wherein the stop ends of the fine join line are configured as a “T” shape, and both sides of the “T” shape of the stop ends are used to prevent the panels from passing through.

6. The air filter according to claim 5, wherein both ends of the fine join line are connected to the panels through the stop ends.

7. The air filter according to claim 3, wherein the air filter media is provided with three join line groups, namely a left join line group, a central join line group and a right join line group, wherein the central join line group is arranged in the middle of the air filter media, and the left join line group and the right join line group are respectively arranged outside the left and right sides of the central join line group, wherein a plurality of fine join lines in a same group are continuously arranged and linearly arranged.

8. The air filter according to claim 7, wherein each two groups of the three join line groups extend parallel to each other, and the three join line groups are not on a same plane, the left join line group and the right join line group are located on a first plane, and the central join line group is located on a second plane, wherein the second plane is parallel to the first plane.

9. The air filter according to claim 7, wherein the fine join lines of the left join line group and the right join line group are arranged at positions close to the pleat tips, with one end penetrating through the left panel of the left pleated section, and the other end penetrating through the right panel of the right pleated section; and wherein the fine join lines of the central join line group are arranged at positions farther from the pleat tips than the fine join lines of the left join line group and the right join line group; or
the fine join lines of the central join line group are arranged at positions close to the pleat tips, with one end penetrating through the left panel of the left pleated section, and the other end penetrating through the right panel of the right pleated section, and the fine join lines of the left join line group and the right join line group are arranged at positions farther from the pleat tips than the fine join lines of the central join line group.

10. The air filter according to claim 9, wherein three consecutive pleated sections are arranged in left, middle and right positions, and at least some of the plurality of fine join lines have one end penetrating through the right panel of the left pleated section, the other end penetrating through the left panel of the right pleated section, and a middle part penetrating through the left panel and the right panel of the middle pleated section.

11. The air filter according to claim 1, wherein the frame further comprises a left frame configured to connect a left end of the top frame and a left end of the bottom frame and a right frame configured to connect a right end of the top frame and a right end of the bottom frame, and the frame surrounds the air filter media in an air-tight joint manner, wherein a plurality of first connecting holes are provided on both the left frame and the right frame, and second connecting holes for connecting with the first connecting holes are provided on both the left frame and the right frame.

12. The air filter according to claim 11, wherein both the front and back sides of the left frame and the right frame extend to form lateral plates, and the first connecting holes are provided on the lateral plates; and wherein the lateral plates are further provided with several apertures for increasing a ventilation area of a filter element when the air filter is assembled; and wherein there are also scale lines on the front and back sides of the left frame and the right frame, and a scale is arranged along a length of the left frame or the right frame.

13. The air filter according to claim 1, wherein the air filter media is provided with a support layer to support shaping of the air filter media, and the support layer comprises a metal mesh layer that is deformable and foldable in a pleated manner with the air filter media.

14. The air filter according to claim 1, wherein the air filter media comprises a first layer and a second layer that are attached to each other, the first layer being an adsorption layer with an electrostatic adsorption function, and the second layer being a non-woven fabric with micro-encapsulated probiotics and extracts of Murraya exotica L., wherein the first layer electrostatically adsorbs allergens such as dust in the passing air, and the probiotics and the non-woven fabric with extracts of Murraya exotica L. on the second layer devour the allergens on the first layer.

15. An air filter, comprising:
air filter media folded in a pleated manner to form a plurality of continuous and adjacent pleated sections; and
fine join lines passing through between two adjacent pleated sections for limiting a unfolding distance between the pleated sections.

16. The air filter according to claim 15, wherein the fine join lines are arranged between two adjacent pleated sections and penetrate through panels, and each pleated section comprises a folding line defining a pleat tip and a pair of adjacent panels, wherein the panels comprise a left panel and a right panel adjacent to the folding line, and two adjacent pleated sections are arranged at left and right; and wherein there are a plurality of fine join lines, and at least part of the fine join lines has one end penetrating through the left panel of a left pleated section and the other end penetrating through the right panel of a right pleated section.

17. The air filter according to claim 16, wherein both ends of the fine join line are respectively provided with stop ends in a “T” shape, and two sides of the “T” shape of the stop ends are configured to prevent the panels from passing through, thereby restricting a relative unfolding of the two panels; and wherein some of the fine join lines among the plurality of fine join lines are continuously arranged and linearly arranged, and the fine join lines on a same line form a join line group; and wherein three join line groups are provided on the air filter media, namely a left join line group, a central join line group, and a right join line group, wherein the fine join lines of the left join line group and the right join line group are arranged at positions close to the pleat tips, with one end passing through the left panel of the left pleated section and the other end passing through the right panel of the right pleated section, and the fine join lines of the central join line group are arranged at positions farther from the pleat tips than the fine join lines of the left join line group and the right join line group.

18. The air filter according to claim 15, wherein the air filter media has serrated edges on opposite left and right sides and flat panels on opposite upper and lower sides, and the air filter further comprises a frame that surrounds the air filter media in an airtight joint manner, wherein the frame comprises a top frame, a bottom frame, a left frame, and a right frame, wherein the top frame and the bottom frame are configured to connect the flat panels on the left and right sides of the air filter media, the left frame is configured to connect a left end of the top frame and a left end of the bottom frame, and the right frame is configured to connect a right end of the top frame and a right end of the bottom frame; and wherein the frame surrounds the air filter media in an airtight joint manner, a plurality of first connecting holes are provided on both the left frame and the right frame, and second connecting holes for connecting with the first connecting holes are provided on both the left frame and the right frame; and wherein both the front and back sides of the left frame and the right frame extend to form lateral plates, the first connecting holes are provided on the lateral plates, and several apertures are further provided on the lateral plates for increasing a ventilation area of a filter element when the air filter is assembled; and wherein scale lines are further provided on the front and back sides of the left frame and the right frame, and a scale is arranged along a length of the left frame or the right frame.

19. The air filter according to claim 15, wherein the air filter media comprises a first layer and a second layer that are attached to each other, the first layer being an adsorption layer with an electrostatic adsorption function, and the second layer being a non-woven fabric with micro-encapsulated probiotics and extracts of Murraya exotica L., wherein the first layer electrostatically adsorbs allergens such as dust in the passing air, and the probiotics on the second layer devour the allergens on the first layer.

20. The air filter according to claim 19, wherein a metal mesh layer is provided on the first layer and/or the second layer, and the metal mesh layer is deformable and foldable in a pleated manner with the air filter media to support shaping of the air filter media.
